(19) United States
(12) Patent Application Publication
(10) Pub. No.: US 2009/0049724 A1
(43) Pub. Date: Feb. 26, 2009

(54) Tag-Holder, Such As In Particular for Displaying an Electronic Price Tag

(75) Inventors: Manuel Alves, Tortosendo (PT); Pedro Cunha, Varberg (SE)

Correspondence Address: EGBERT LAW OFFICES, 412 MAIN STREET, 7TH FLOOR, HOUSTON, TX, 77002, US

(73) Assignee: JOALPE INDUSTRIA DE EXPOSITORES, S.A., Tortosendo (PT) (PT)

(21) Appl. No.: 11/815,254

(22) PCT Filed: Jan. 12, 2006
(86) PCT No.: PCT/EP2006/000283

§ 371 Date: Jul. 1, 2008

(30) Foreign Application Priority Data
Feb. 16, 2005 (FR) 05/01538

(51) Int. Cl. G09F 3/20

(52) U.S. Cl. 40/651; 40/661.03

(57) ABSTRACT

The invention concerns a tag-holder for displaying an electronic price tag. The invention includes a holder for a tag, such as an electronic price tag, and a fixing mechanism adapted to be secured at the front of a shelf, in particular, a rack. The invention is characterized in that the fixing mechanism has an eccentric device, clipping the shelf so as to adjust and/or maintain the tag holder on shelves of different thicknesses.

The present invention relates to a tag holder such as in particular for the display of an electronic price tag. It will find a particular application in all the fields of economic activity where it is desirable to display information.

In the field of commercial display, and in particular in selling premises, it is know to arrange a tag holder stick or a profiled mother-stick for supporting a tag holder on the front edge of a shelf.

Generally, the trays of the shelves are of two types. They may be thin, generally consisting of a curved sheet metal at its ends to form the edges of the tray, or may be thick, of the order of half a centimetre, formed, for instance, of a wooden, glass or still plexiglass plate.

So-called thin trays exhibit generally a mounting section on the front edge of the latter. The profiled stick then exhibits adapted fastening means capable of co-operating with the front edge of the tray. Also, for instance, the sheet metal can be folded to form a U-shaped profile on the front edge of the tray. The profiled stick then exhibits snap-on means capable of co-operating with the U.

So-called thick trays do not exhibit generally any assembly section. The tag holders then exhibit generally a rear profile forming an elastic jaw. This jaw will then pinch the front edge of the tray and thus provides for the attachment of the profiled stick. Nevertheless, the long-term resistance of the tag holder is mediocre, wherein the profiled stick and in particular the tag holder coming loose from the tray when pulling slightly thereon.

The fastening of the profiled sticks or tag holder by adhesive is also known. Nevertheless, this method is little convenient when changing parts. Indeed, when removing the sticks or the tag holders, the adhesive will peel off, wherein a portion of the adhesive stays on the surface of the tray. The adhesive remains will then catch dust, and makes the shelves little attractive. It must be removed and the tray cleaned.

The aim of the present invention is to provide a tag holder which remedies the shortcomings aforementioned, providing an attachment to a so-called thick shelf efficiently.

Another aim of the invention is to provide a tag holder enabling an attachment to trays of different thicknesses.

Other aims and advantages of the invention will appear in the following description, which is given only by way of example and without being limited thereto.

The invention relates to a tag holder, in particular for the display of an electronic price tag, including at least means for supporting a tag, such as in particular an electronic price tag, as well fastening means capable of being slaved at the front of a tray, in particular a shelf, characterised in that said fastening means exhibit eccentric means for pinching the tray enabling to adjust and to hold the tag holder on trays of different thicknesses.

The invention will be understood better when reading the following description, accompanied by the appended drawings which are integral part thereof and among which:

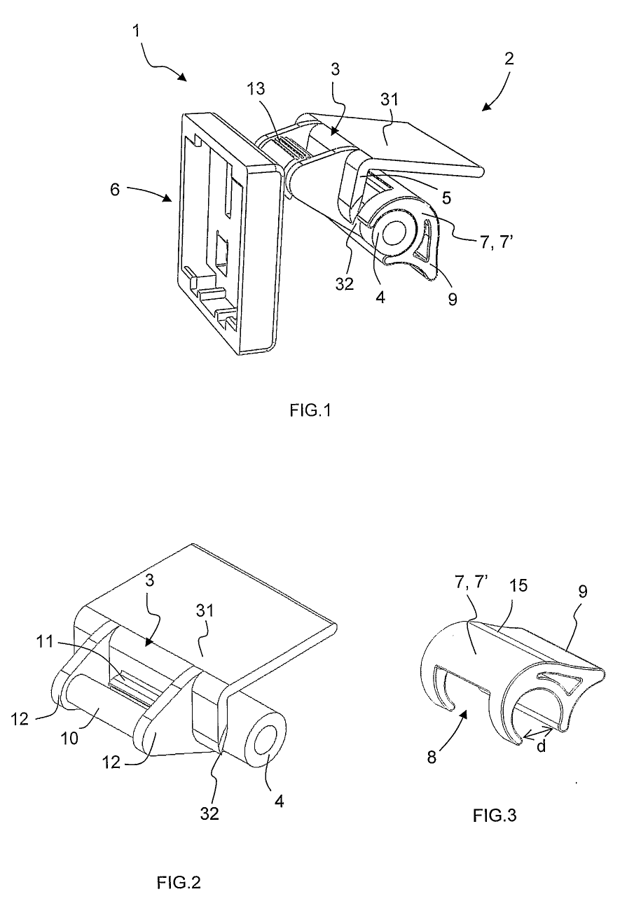

FIG. 1 is a perspective view of an assembled tag holder exhibiting fastening means according to the invention,

FIG. 2 is a perspective view of a structure of a C-shaped profile of the fastening means as illustrated on FIG. 1,

FIG. 3 is a perspective view of the eccentric means for pinching the tray as illustrated on FIG. 1,

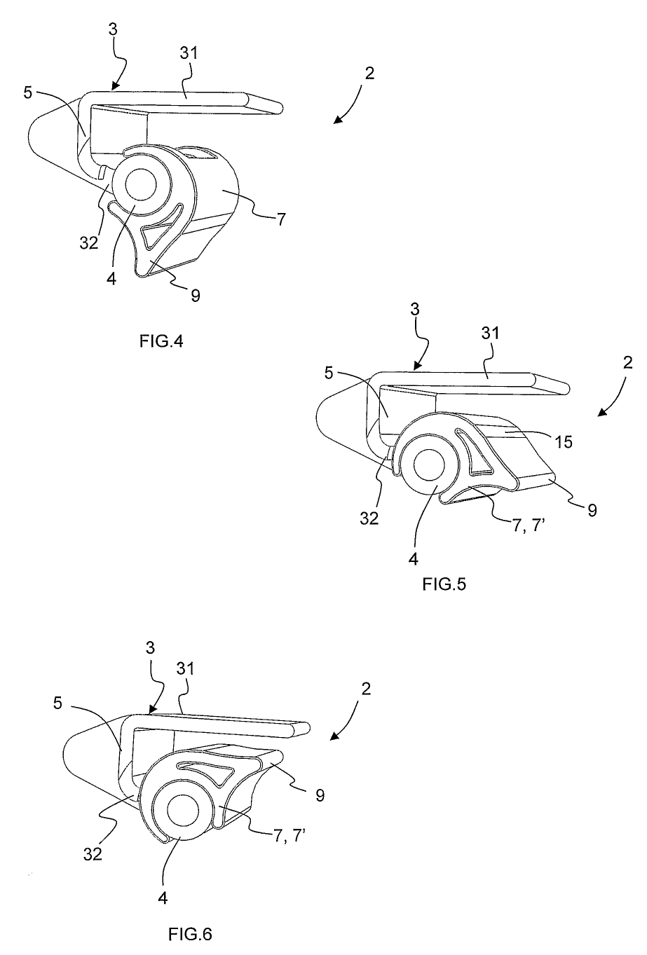

FIG. 4 is a perspective view of the fastening means as illustrated on FIG. 1, the eccentric means being placed in a retracted position,

FIG. 5 is a view of the fastening means as illustrated on FIG. 4, the eccentric means being placed in an intermediate engaging position,

FIG. 6 is a view of the fastening means as illustrated on FIG. 4, the eccentric means being placed in a final and optimal pinching position,

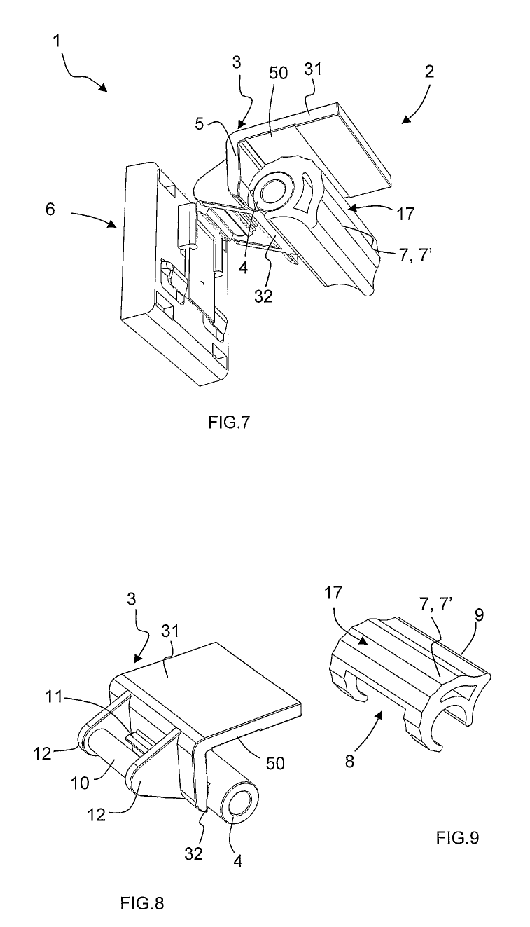

FIG. 7 is a perspective view of an assembled tag holder exhibiting fastening means according to the invention in a second embodiment,

FIG. 8 is a perspective view of a structure of a C-shaped profile of the fastening means as illustrated on FIG. 7,

FIG. 9 is a perspective view of the eccentric means for pinching the tray as illustrated on FIG. 7,

The invention relates to a tag holder, such as in particular for the display of an electronic price tag, including at least means for supporting a tag, such as in particular an electronic price tag, as well fastening means capable of being slaved at the front of a tray, in particular a shelf.

According to the invention, the fastening means exhibit eccentric means 7 for pinching the tray enabling to adjust and/or to hold the tag holder on trays of different thicknesses.

Also, the eccentric means enable to attach the tag holder shelves, and in particular trays of different thicknesses. They enable in particular to adjust and/or to fasten the tag holder on shelves of 4 mm to 8 mm in thickness, without being however limiter to such interval.

Advantageously, according to an embodiment, the eccentric means are self-clamping when drawn by the tag holder. As illustrated on Figures, when the tag holder is subjected to traction, the eccentric means are driven so that they increase the pinching load on the tray, thereby holding the tag holder solidly. Thus, the eccentric means grasp the tray and react to a tensile load while opposing higher friction loads to the latter.

As illustrated on FIG. 2, wherein the fastening means exhibit a structure of C-shaped profile, the horizontal wings 31, 32 of the C-shaped structure being spaced apart by a distance sufficient for being placed on both sides of the front edge of said tray, the vertical wing of the C-shaped structure being capable of abutting against the front edge of said tray.

As illustrated on Figures, the upper horizontal wing 31 of the C-shaped structure is of size greater than the lower wing 32.

The eccentric means 7 are arranged at such a horizontal wing of the structure of C-shaped profile, and consisting of a pivoting eccentric 7′.

As illustrated on Figures, the eccentric is hinged at the lower wing 32 of the C-shaped structure.

According to an embodiment, one of the horizontal wings of the C-shaped structure exhibits at the end thereof a pivot pin 4, transversal and horizontal, around which said eccentric is pivoting.

The eccentric exhibits a longitudinal straight opening of width d smaller than the diameter of said transversal pivot pin 4, thereby enabling to snap-on the eccentric 7′ by resilient deformation.

As illustrated on FIG. 3 in particular, the eccentric exhibits a globally cylindrical body.

The longitudinal straight opening of width d emerges on a substantially cylindrical, longitudinal recess of diameter substantially equal to the diameter of the transversal pivot pin 4.

The pivot pin 4 can be in particular, as illustrated on Figures, tubular. The transversal pivot pin 4 forms with one 32 of the horizontal wings of the C-shaped structure a T-shaped structure. The eccentric 7′ then exhibits a central cut-out 8 letting through the vertical wing 32 of the T-shaped structure, when rotating.

The eccentric 7′ exhibits a protrusion 9 with a lever function. As illustrated on FIG. 4. Said eccentric 7′ is arranged on the lower wing 32 of the structure of C-shaped profile, said protrusion 9 of the eccentric protruding downwards when the eccentric 7′ exhibits its smallest radius opposite the upper horizontal wing 31 of the structure of C-shaped profile.

As illustrated on FIG. 6, the eccentric 7′ exhibits its highest radius opposite the upper horizontal wing 31 of the structure of C-shaped profile after approximately one quarter turn rotation thereof.

The eccentric exhibits, in this end pinching position, a flat surface zone 15 in order to prevent any reverse rotation of the latter. In this end position, the protrusion 5 is arranged substantially parallel to the tray (not illustrated).

Also, contrary to the state of the art which requires generally tools for disassembly, the fastening means of the tag holder may be actuated manually while causing the rotation of the eccentric while resting on the protrusion 9.

In a second embodiment of the fastening means 2 illustrated on FIGS. 7 to 9, the eccentric means 7 exhibit a faceted contact surface 17.

Also, as illustrated on FIG. 9, the eccentric 7′ exhibits flat flutes on its circumference. Such an arrangement enables advantageously to increase the attachment of the tag holder to the tray.

Besides, the upper wing 31 of the structure of C-shaped profile may exhibit contact means to increase the friction coefficient with the tray.

Also, as illustrated on FIG. 7 in particular, a groove 50 is provided on the lower surface of the upper wing 31 for the reception of a band of adhesive material. The band of adhesive material could also be formed of a PVC exhibiting characteristics considered as flexible or tender.

According to an embodiment, the tag holder 1 exhibits hinging means acting as an interface between said fastening means 3 to the tray and the means 6 for supporting a tag. Also, the tag can be oriented along different viewing angles according to the height of the tray in the shelf.

As illustrated on FIG. 2, the rotating means consist of a pivot pin 10 around which is mounted rotatably a pivot part 13. The pivot pin 10 is arranged between two flanks 12 moving apart from the vertical wing 5 of the structure of C-shaped profile.

Advantageously, the pivot part 13 exhibits indexing means enabling to hold the tag holder at a given angle. The pivot part 13 may then be in the form of a toothed gear 13, whereof the toothing is capable of co-operating with a ratchet 11 slaved to the C-shaped structure.

The means 6 for supporting a tag may be in particular in the form, as illustrated on FIG. 6 of a supporting frame, for embedding an electronic price tag.

Nevertheless, the supporting means 6 may be in any other shape and in particular the forms of a pocket for a cardboard tag.

The invention will be advantageously manufactured in plastic materials by injection-moulding processes. Nevertheless, according to the embodiments, other materials may be used such as aluminium.

1. A tag holder for display of an electronic price tag, said tag holder comprising:
a means for supporting a tag; and
a fastening means being slaved at a front of a tray of a shelf, said fastening means being comprised of an eccentric means pinching the tray enabling adjustment and mounting on trays of different thicknesses.

2. A tag holder according to claim 1, wherein said eccentric means are self-clamping.

3. A tag holder according to claim 1, wherein said fastening means is further comprised of a structure with a C-shaped profile and horizontal wings, said horizontal wings being spaced apart by a distance sufficient for being placed on both sides of the front edge of said tray, said structure with a C-shaped profile having a vertical wing abutting against the front edge of said tray.

4. A tag holder according to claim 3, wherein said eccentric means are arranged at such a horizontal wing and comprised of a pivoting eccentric.

5. A tag holder according to claim 4, wherein one horizontal wing has a pivot pin at an end thereof, being transversal and horizontal, said pivoting eccentric pivoting around said pivot pin.

6. A tag holder according to claim 4, wherein said eccentric means is comprised of a faceted contact surface.

7. A tag holder according to claim 5, wherein pivoting eccentric has a longitudinal straight opening of a width smaller than a diameter of said pivot pin transversal, said pivoting eccentric being snap-fit by resilient deformation.

8. A tag holder according to claim 5, wherein said pivot pin transversal and one horizontal wing form a T-shaped structure, said pivoting eccentric having a central cut-out, the T-shaped having a vertical wing passing through said central cut-out when rotating.

9. A tag holder according to claim 4, wherein said pivoting eccentric is comprised of a protrusion with a lever function.

10. A tag holder according to claim 3, wherein the upper wing of the structure of C-shaped profile is comprised of a contact means to increase a friction coefficient with the tray.
